(19) United States
(12) Patent Application Publication
(10) Pub. No.: US 2026/0371169 A1
(43) Pub. Date: Nov. 19, 2026

(54) SYSTEM AND METHOD FOR OVERSEEING NETWORK RELIABILITY IN O-RAN ARCHITECTURES

(71) Applicant: AT&T Intellectual Property I, L.P., Atlanta, GA (US)

(72) Inventors: Yuxuan Jiang, Piscataway, NJ (US); Yu Zhou, Somerset, NJ (US)

(73) Assignee: AT&T Intellectual Property I, L.P., Atlanta, GA (US)

(21) Appl. No.: 19/209,960

(22) Filed: May 16, 2025

(51) Int. Cl. H04W 28/08; H04W 24/04; H04W 28/18

(52) U.S. Cl. CPC H04W 28/0925; H04W 24/04; H04W 28/18

(57) ABSTRACT

Aspects of the subject disclosure may include, for example, an oversight framework and system for managing RAN automation applications within an O-RAN architecture. The system evaluates API calls made by RAN automation applications, including read requests for network data and write requests for network configuration parameters, ensuring compliance with operational standards. It involves generating feedback to RAN automation applications through response messages, issuing alarms based on detected anomalies, and resolving conflicts in network parameter settings using a rule-based approach and data-driven approaches. The framework also facilitates resource reallocation across RAN Intelligent Controllers to support auditing processes, utilizing a real-time analyzer and a long-term analyzer to assess the impact of write requests. Other embodiments are disclosed.

### FIELD OF THE DISCLOSURE

The subject disclosure relates to a system and method for overseeing network reliability in O-RAN architectures.

### BACKGROUND

The Open Radio Access Network (O-RAN) architecture is increasingly being adopted by leading wireless operators to enhance network flexibility and interoperability. O-RAN facilitates the integration of RAN automation applications, such as rAPPs and xAPPs, which are designed to improve network performance through data-driven decision-making processes. These applications leverage advanced technologies, including machine learning, to analyze network data and optimize configurations dynamically.

Machine learning techniques, particularly deep learning and generative AI have become important components of RAN automation applications. These techniques enable applications to process large volumes of network data and make sophisticated decisions that can enhance network efficiency and user experience. The use of machine learning in telecommunications is expanding, offering capabilities that were previously unattainable with traditional methods.

Third-party RAN automation applications are being introduced into production networks, providing innovative solutions that complement the capabilities of operator-developed applications. These third-party applications are developed by various vendors and are integrated into the O-RAN architecture through standardized interfaces. The collaboration between network operators and third-party vendors is fostering a diverse ecosystem of applications that contribute to the overall advancement of network technologies.

The O-RAN architecture defines standard interfaces, such as the R1 interface and near-Real Time RAN Intelligent Controller (near-RT RIC) Application Programming Interface (API), which facilitate communication between RAN automation applications and the network infrastructure. These interfaces enable applications to access network data and implement configuration changes, thereby playing a role in the dynamic management of network resources. The standardization of these interfaces is important in ensuring seamless integration and operation of diverse applications within the O-RAN framework.

Wireless networks are characterized by a vast array of configurable parameters that govern various aspects of network operation. Management of these parameters can be important for maintaining network stability and performance. As networks evolve, the complexity of parameter interactions increases, necessitating sophisticated approaches to parameter management. The ability to dynamically adjust network configurations in response to changing conditions is an important feature of modern telecommunications systems.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A illustrates an example O-RAN-based network in which a non-Real Time RAN Intelligent Controller (non-RT RIC) oversight framework and a near-RT RIC oversight framework are deployed at an R1 terminus and near-RT RIC API terminus respectively, in accordance with various aspects described herein.

FIG. 2B illustrates an example of the non-RT RIC oversight framework and near-RT RIC oversight framework in accordance with various aspects described herein.

FIG. 2C1 and FIG. 2C2 illustrate an example of the non-RT RIC oversight framework processing an incoming read request and an incoming write request from rAPPs in accordance with various aspects described herein.

FIG. 2D illustrates an example of the near-RT RIC oversight framework processing a read request from xAPPs in accordance with various aspects described herein.

FIG. 2E illustrates an example of the near-RT RIC oversight framework processing a write request from xAPPs in accordance with various aspects described herein.

FIG. 2F illustrates an example of the non-RT RIC oversight framework auditor module processing write requests from rAPPs in accordance with various aspects described herein.

FIG. 2G illustrates an example of the near-RT RIC oversight framework auditor module processing write requests from xAPPs in accordance with various aspects described herein.

FIG. 2H illustrates an example of the non-RT RIC oversight framework conducting automated periodic updates to monitoring strategies using adaptive learning in accordance with various aspects described herein.

FIG. 2I illustrates an example of the non-RT RIC and near-RT RIC oversight frameworks receiving rule-based updates from a RAN administrator in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for an oversight framework designed to manage and regulate RAN automation applications within the O-RAN architecture. This oversight framework can be strategically positioned at the termination points of critical interfaces, such as the R1 interface and the near-RT RIC API, to ensure the secure and efficient operation of rAPPs and xAPPs.

In one or more embodiments, the oversight framework comprises a suite of modules that perform important functions, including behavior monitoring, compliance assurance, conflict resolution, and auditing. These modules can collaboratively evaluate API calls made by RAN automation applications, including rAPPs and xAPPs, ensuring that read requests for network data and write requests for network configuration parameters comply with established operational standards. By generating feedback through response messages, the framework informs RAN automation applications of the impact of their API calls on network performance, promoting a cycle of continuous improvement.

In one or more embodiments, the oversight framework can be equipped with mechanisms to issue alarms based on detected anomalies or non-compliance, providing timely alerts to network administrators. In another embodiment, the oversight framework facilitates interaction through a graphical user interface, allowing administrators to visualize system health, operational statistics, and update compliance rules, whitelists, and blacklists. The oversight framework's auditing capabilities can be enhanced by machine learning techniques, which predict and prevent adverse effects of write requests, ensuring long-term network stability.

Additionally, the oversight framework can support communication between the non-RT RIC and the near-RT RIC over the A1 interface, enabling coordinated decision-making and optimization of network resources. By storing historical data of API calls and their outcomes, the oversight framework can leverage adaptive learning to dynamically update monitoring strategies, ensuring responsive and effective network management. Through these comprehensive oversight and management functions, the oversight framework can play a central role in maintaining the reliability, safety, and/or performance of O-RAN-based networks.

One or more aspects of the subject disclosure include a method, comprising: evaluating, by a processing system including a processor, API calls made by RAN automation applications, wherein the API calls include read requests for network data and write requests for network configuration parameters; and based on the evaluating, providing, by the processing system, to at least a portion of the RAN automation applications, response messages associated with at least a portion of the API calls, wherein the response messages include feedback that reflects an impact of the API calls on a network performance.

One or more aspects of the subject disclosure include a processing system, comprising: a processor; and a memory that stores executable instructions that, when executed the processing system, facilitate performance of operations, the operations comprising: evaluating API calls made by RAN automation applications, wherein the API calls include at least one of read requests for network data, write requests for network configuration parameters, or a combination thereof, wherein the evaluating includes determining an impact of the API calls on a network performance; and auditing the API calls to assess their potential impact on the network performance, wherein the auditing is facilitated by data-driven approaches to predict adverse effects on the network performance, wherein the auditing is performed over a longer time period than the evaluating.

One or more aspects of the subject disclosure include a non-transitory machine-readable medium, comprising executable instructions that, when executed by a processing system including a processor of a device, facilitate performance of operations, the operations comprising: evaluating API calls made by RAN automation applications, wherein the API calls include read requests for network data and write requests for network configuration parameters; and based on the evaluating, providing, to at least a portion of the RAN automation applications, response messages associated with at least a portion of the API calls, wherein the response messages include feedback that reflects an impact of the API calls on a network performance.

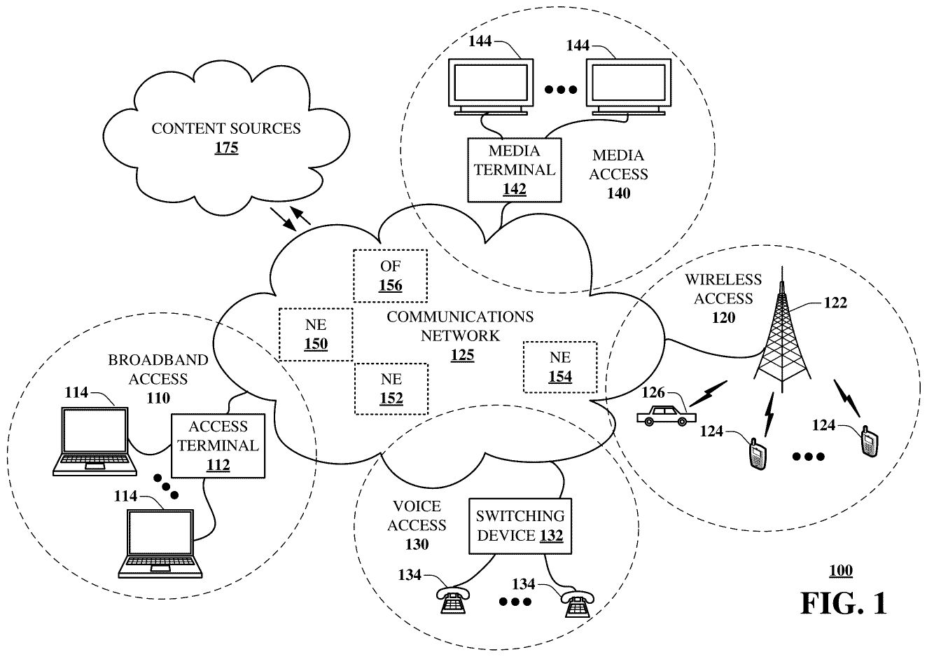

Referring now to FIG. 1, a block diagram is shown illustrating an example, non-limiting embodiment of a system 100 in accordance with various aspects described herein. For example, system 100 can facilitate in whole or in part the evaluation of API calls made by RAN automation applications, including read requests for network data and write requests for network configuration parameters. The system can generate feedback to the RAN automation applications through response messages to API calls, reflecting the impact of these calls on network performance. System 100 also can issue alarms based on detected anomalies or non-compliance in API calls and resolve conflicts in network parameter settings initiated by the RAN automation applications, ensuring improved or optimal network performance and compliance with operational standards. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text, and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices

In various embodiments, the media terminal 142 can include a cable head-end or other TV head-end, a satellite receiver, gateway, or other media terminal 142. The display devices 144 can include televisions with or without a set top box, personal computers, and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

FIG. 1 also shows an example embodiment of an oversight framework (OF) 156. In one or more embodiments, oversight framework 156 functions as a component within the communications network, overseeing the management and optimization of API calls made by RAN automation applications across various access channels, including broadband, wireless, voice, and media access. Positioned within the network infrastructure, the oversight framework 156 can interface with multiple network elements, such as routers, switches, and controllers, to ensure compliance with operational standards and optimize network performance. This integration ensures that API calls are efficiently monitored and managed, providing a stable environment for network operations. In other embodiments, the oversight framework 156 or portions thereof can reside outside of the network infrastructure, such as via cloud computing and/or virtual functions that may make use of third-party devices and/or functionality.

In some embodiments, the oversight framework 156 acts as a supervisory entity that evaluates API calls and applies compliance measures, thereby enhancing the network's ability to maintain reliability and performance. For example, the oversight framework 156 may be responsible for monitoring API interactions and generating feedback to RAN automation applications, ensuring that network configurations are optimized, improved and/or aligned with policies including predefined policies. During the evaluation process, the oversight framework 156 can facilitate the assessment of API calls and the application of compliance rules, ensuring that network operations are managed efficiently and effectively. In the feedback generation process, the oversight framework 156 can provide insights into network performance impacts, enabling RAN automation applications to adjust their operations accordingly.

Furthermore, the oversight framework 156 can handle real-time and/or near-real-time monitoring, where alarms are issued by the oversight framework based on detected anomalies or non-compliance and/or where the oversight framework or other computing devices can resolve conflicts in network parameter settings. In one or more embodiments, this can ensure that only compliant API calls are processed and that operational standards are consistently upheld. By coordinating with other components in the network, the oversight framework 156 supports seamless communication and robust management, contributing to the efficient operation of the system as a whole. The oversight framework 156 enhances network stability and operational efficiency, providing a centralized platform for monitoring API interactions and enforcing compliance across various network flows. However, as described herein, a de-centralized or distributed platform for monitoring API interactions and enforcing compliance across various network flows can be provided in other embodiments.

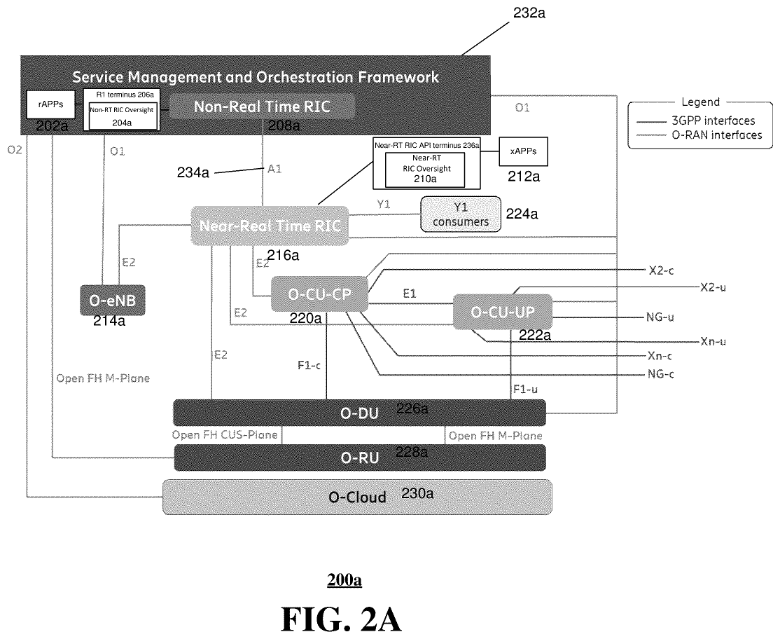

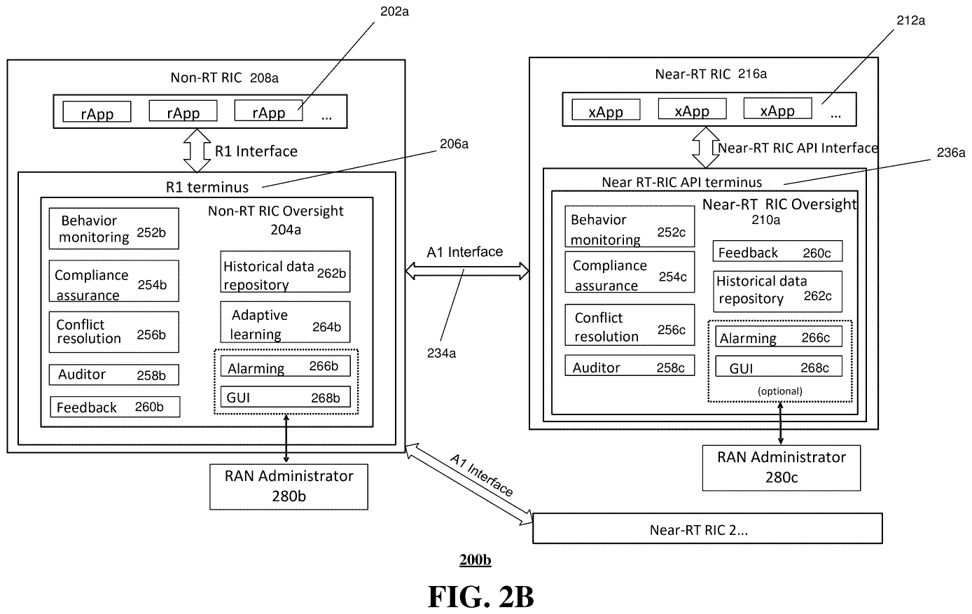

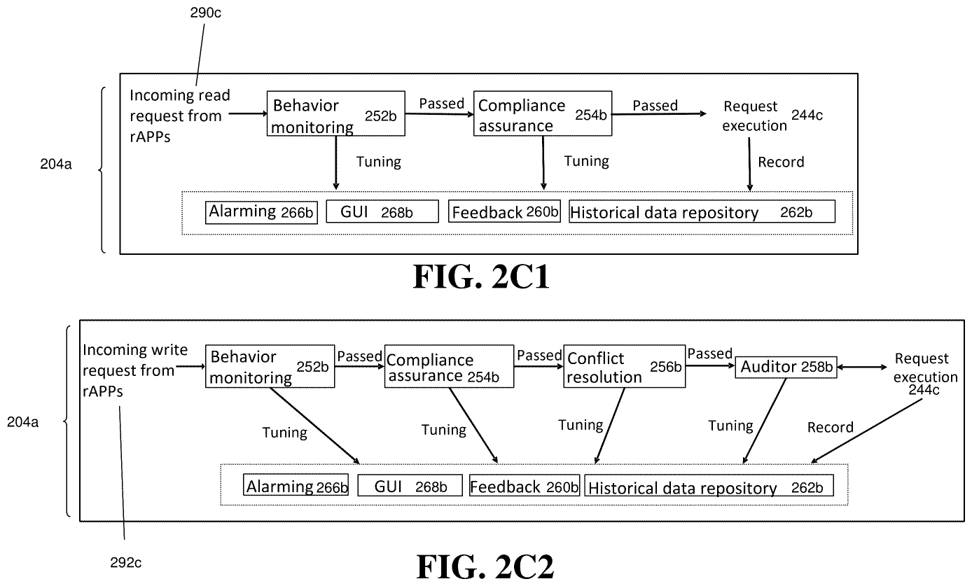

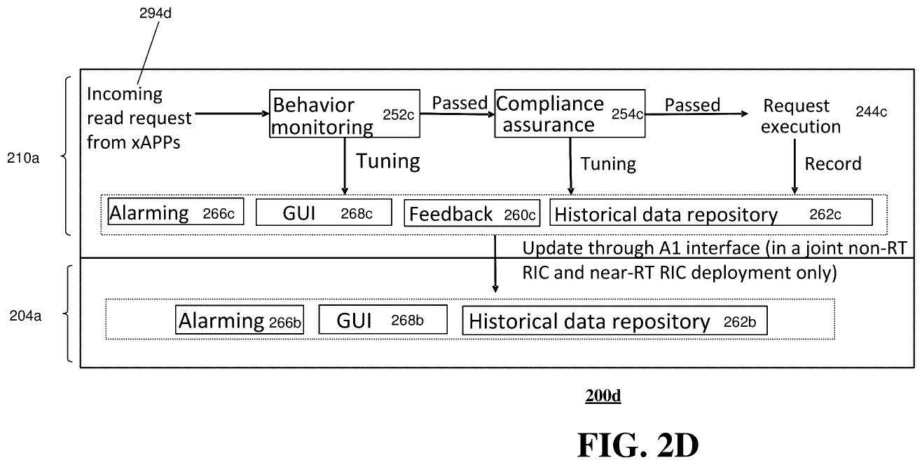

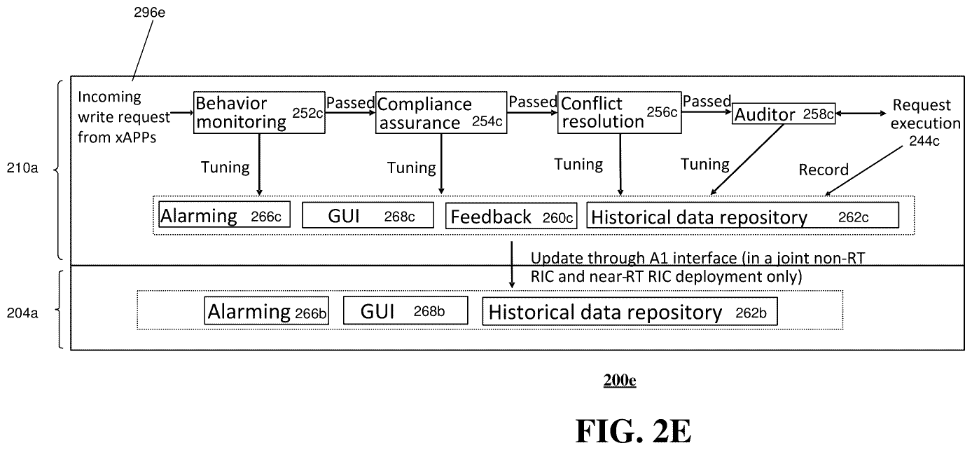

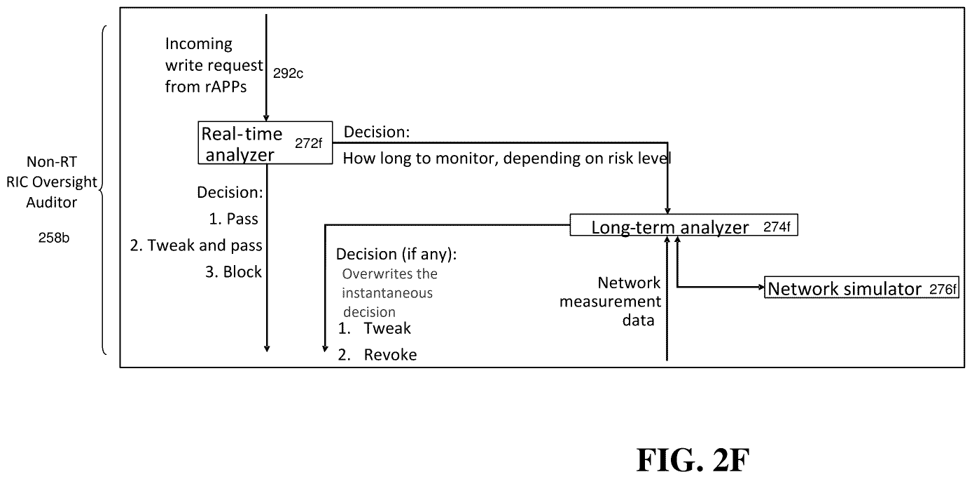

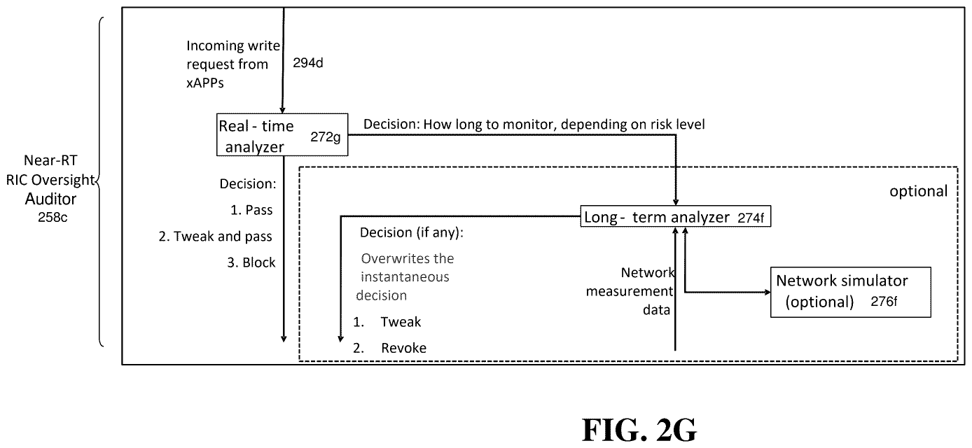

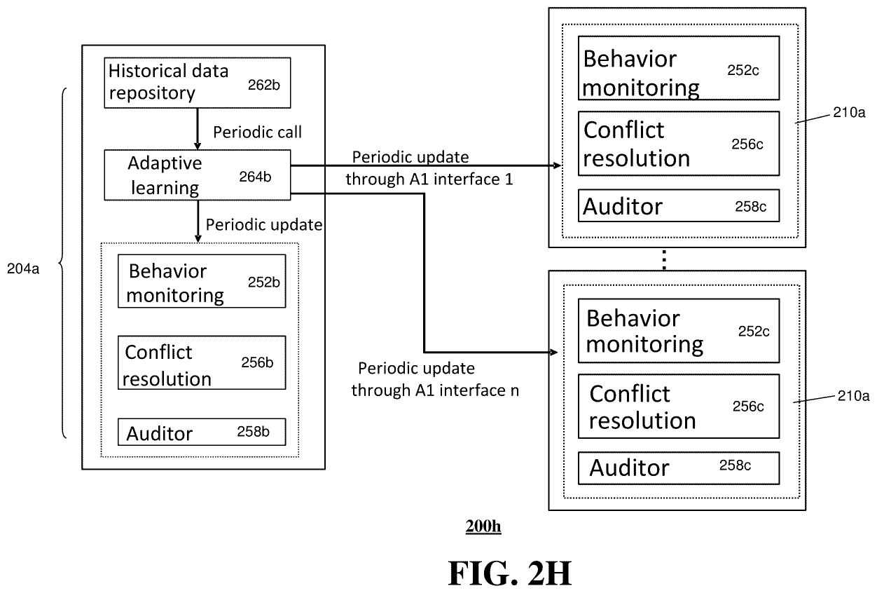

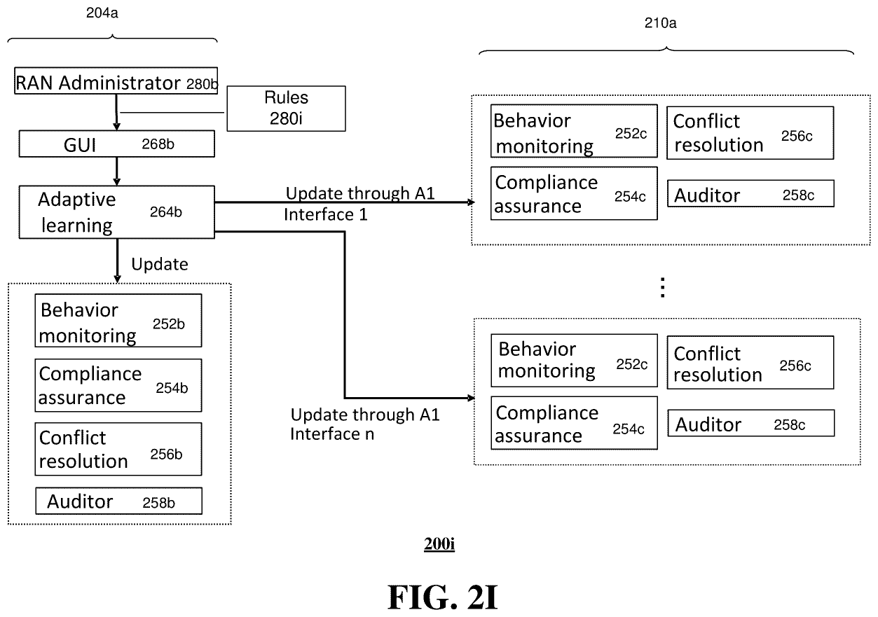

FIG. 2A is a block diagram illustrating an example, non-limiting embodiment of an oversight framework system 200a functioning within the communication network of FIG. 1 in accordance with various aspects described herein. FIG. 2A provides a detailed view of the components and interactions involved in the oversight framework system 200a, highlighting the oversight framework's integration within an example O-RAN architecture.

Within the Service Management and Orchestration (SMO) framework 232a depicted in FIG. 2A, several components collaborate to improve or optimize and manage network operations. The SMO framework 232a serves as a high-level entity responsible for coordinating, monitoring, and optimizing the network. The SMO framework 232a can act as the central hub for managing interactions between RAN automation applications and the network infrastructure, ensuring efficient and effective network management.

In various embodiments, as part of the SMO framework 232a, Non-RT RIC Applications (rAPPs) 202a, or RAN automation applications, function as components within the O-RAN architecture, designed to perform long-term network optimization and planning tasks. These applications can leverage data-driven insights to enhance network performance by analyzing vast amounts of network data and making strategic decisions. Operating within the Service Management and Orchestration framework 232a, rAPPs 202a interact with the non-RT RIC 208a through the R1 interface, sending API calls for data requests and configuration changes. By doing so, rAPPs 202a contribute to the overall efficiency and adaptability of the network.

The non-RT RIC Oversight framework 204a is responsible for monitoring and managing API calls made by rAPPs 202a, ensuring compliance with operational standards and optimizing or improving network configurations. Positioned at the R1 terminus 206a, the non-RT RIC oversight framework 204a evaluates API interactions and applies compliance measures to maintain network stability and performance. The termination of the R1 interface 206a serves as the point of connection between rAPPs 202a and the non-RT RIC 208a, facilitating communication and ensuring that API calls adhere to predefined standards. The non-RT RIC oversight framework 204a is strategically positioned at this terminus to effectively manage and oversee the interactions between rAPPs 202a and the network infrastructure. By being positioned at the terminus, the non-RT RIC oversight framework 204a can directly evaluate and process API calls from the rAPPs 202a, applying compliance measures and optimizing network configurations. This positioning allows the non-RT RIC oversight framework 204a to implement long-term network optimization and planning tasks, ensuring that the strategic decisions made by rAPPs align with operational standards and contribute positively to network performance.

The non-RT RIC 208a within the SMO framework 232a can be utilized for overseeing long-term network improvement, optimization and/or planning. The non-RT RIC processes API calls from rAPPs 202a to implement strategic network management tasks, interacting with rAPPs 202a through the R1 interface to receive data and configuration requests that enhance network performance over time.

The near-RT RIC 216a is connected to the non-RT RIC 208a via the A1 interface 234a. This interface is for policy management and coordination, allowing the non-RT RIC 208a to communicate long-term strategies and policies to the near-RT RIC 216a, which can then implement these strategies in real-time or near-real time operations. In another embodiment, the non-RT RIC oversight framework 204a can generate policy information based on the evaluating and auditing of API calls made by rAPPs and xAPPs. For example, the non-RT RIC oversight framework can analyze API call patterns, compliance results, and network performance impacts to create policy information that adjusts the behavior of rAPPs and xAPPs. This policy information may include rate-limiting rules, prioritization strategies, or parameter adjustment guidelines to optimize network performance and ensure compliance with operational standards. The policy information is then communicated from the non-RT RIC 216a to the near-RT RIC 208a via the A1 interface, enabling the near-RT RIC to implement these strategies in real-time operations.

The near-RT RIC interacts with Near-RT RIC Applications (xAPPs) 212a through the near-RT RIC API terminus 236a. The near-RT RIC API terminus 236a serves as the interface point through which xAPPs 212a communicate with the near-RT RIC 216a, sending API calls for near-real time network control and optimization. xAPPs 212a are used for executing rapid adjustments and optimizations in response to changing network conditions, ensuring that the network remains efficient and responsive. xAPPs 212a utilize advanced algorithms and data analytics to make quick decisions that optimize or improve resource allocation, manage traffic loads, and maintain service quality. Within the near-RT RIC oversight framework 210a, xAPPs 212a are monitored to ensure their API calls comply with operational standards, and their interactions are managed to prevent conflicts and maintain network stability. This oversight ensures that xAPPs 212a can effectively contribute to the network's near-real time operational goals while aligning with long-term strategic objectives.

The near-RT RIC oversight framework 210a monitors and manages API calls made by xAPPs 212a. The near-RT RIC oversight framework 210a ensures that the API calls comply with operational standards and optimizes network configurations in real-time, on the level of milliseconds. Positioned at the near-RT RIC API terminus 236a, the near-RT RIC oversight framework 210a evaluates API interactions and applies compliance measures to maintain network stability and performance.

In some embodiments, the near-RT RIC 216a works in conjunction with the non-RT RIC 208a to provide a comprehensive and adaptive network management strategy. The A1 interface 234a facilitates this collaboration, enabling coordinated decision-making and optimization of network resources. The near-RT RIC oversight framework 210a and non-RT RIC oversight framework 208a, strategically positioned at critical interface terminations, can play an important role in this process by monitoring and evaluating API calls made by RAN automation applications, ensuring compliance with operational standards and preventing potential negative impacts on the network. By relying on these components, the near-RT RIC 208a can ensure that real-time network operations are aligned with long-term strategic objectives, enhancing the overall reliability and efficiency of the network.

In the context of the O-RAN system depicted in FIG. 2A, several components collaborate to facilitate efficient and dynamic network operations. The O-RAN evolved Node B (O-eNB) 214a serves as a base station component within the O-RAN system, facilitating communication with user devices by handling the transmission and reception of radio signals. The O-eNB 214a is important for maintaining connectivity and supporting mobile communications within the network. The O-RAN Central Unit-Control Plane (O-CU-CP) 220a and O-RAN Central Unit-User Plane (O-CU-UP) 222a are responsible for processing control and user data within the network. The O-CU-CP 220a manages signaling and control functions, while the O-CU-UP 22a handles user data traffic, ensuring efficient data flow and supporting the network's operational requirements.

The O-RAN Distributed Unit (O-DU) 226a processes radio signals and interfaces with the O-RAN Radio Unit (O-RU) 228a. The O-DU plays an important role in managing the physical layer of the network, ensuring that radio communications are effectively transmitted and received. The O-RU 228a is responsible for transmitting and receiving radio signals to and from user devices, interfacing with the O-DU 226a to facilitate seamless communication and maintain network coverage. The O-Cloud 230a represents the cloud infrastructure that supports virtualized network functions and provides the necessary computing resources for network operations. The O-Cloud 230a enables scalability and flexibility, allowing the network to adapt to changing conditions and demands.

The Y1 Consumers 224a represent the end-users or devices (e.g., mobile phones, computers, vehicle computing systems, and so forth) that consume network services, relying on the network's infrastructure for connectivity and communication. The integration of the O-eNB 214a, O-CU-CP 220a, O-CU-UP 222a, O-DU 226a, O-RU 228a, O-Cloud 230a, and Y1 Consumers 224a ensures that the network can support both real-time and long-term management strategies, maintaining high performance and adaptability. These components work in concert to deliver reliable and efficient network services within the O-RAN system.

FIG. 2B is a block diagram illustrating an example, non-limiting embodiment of an oversight framework system 200b with various aspects described herein. This diagram provides a detailed view of the components and interactions within the O-RAN architecture, focusing on both the non-RT RIC 208a and the near-RT RIC 216a.

Within the non-RT RIC oversight framework 204a, the RAN Intelligent Controller applications, rAPPs 202a are positioned to interact with the non-RT RIC 208a through the R1 Interface at the R1 terminus 206a. The non-RT RIC oversight framework 204a is responsible for monitoring and managing API calls made by rAPPs 202a, ensuring compliance with operational standards. The described arrangement is exemplary and may exist in other formats or configurations depending on deployment scenarios or specific network requirements. This grouping includes several modules discussed herein.

In one embodiment, behavior monitoring 252b, can track API call patterns. This module continuously, frequently, or according to other timing schemes tracks the number and nature of API calls made by each RAN automation application, such as call type, response time, error rate, and/or resource usage. Behavior monitoring 252b allows the non-RT RIC oversight framework 204a to promptly identify any unusual or excessive API calls. For example, if an application starts to make an unusually high number of API calls or highly similar API calls repetitively, or the API calls made by an application incurs a high error rate in the responses, the module will flag this behavior, such as harmful, and will notify the alarming module 266b and/or take corrective actions, such as blocking the applications from making API calls for a certain period of time. Another example is that this module can implement a rate-limiting mechanism, such as distributing the surge API calls that arrive within a short time period over a longer time window, smoothing out the demand and reducing the risk of processing overload. The rate-limiting mechanism can include various approaches, such as setting thresholds for the maximum number of API calls allowed within a specific time frame, prioritizing certain types of API calls based on their impact on network performance, or dynamically adjusting rate limits based on real-time network conditions. For instance, critical API calls related to fault management may be given higher priority, while non-essential calls, such as performance monitoring requests, may be delayed or batched. Additionally, the mechanism can incorporate token-based systems, where API calls are processed only if sufficient tokens are available, or queue-based systems, where incoming calls are placed in a queue and processed sequentially to prevent overload. Note that the strategy to identify unusual API call patterns and apply rate-limiting can be dynamically updated, for example, by an adaptive learning module 264b based on the analysis of historical API calls, ensuring that the rate-limiting mechanism evolves to address changing network conditions and application behaviors. The rate-limiting mechanism can be implemented by monitoring the frequency of specific API call types over defined intervals or by analyzing cumulative call volumes to enforce limits dynamically.

In another embodiment, the behavior monitoring module 252b can monitor key performance metrics associated with network health, such as latency, throughput, packet loss, or signal quality. If any of these metrics fail to satisfy predefined thresholds, the module can identify the underlying cause, such as excessive API call frequency or resource contention, and/or trigger alarms through the alarming module 266b to notify the RAN administrator. Additionally, the behavior monitoring module 252b can initiate corrective actions, such as rate-limiting specific API calls or reallocating network resources, to restore performance to acceptable levels. These thresholds can be dynamically updated based on historical data and real-time network conditions, ensuring the module remains responsive to evolving network demands.

In one embodiment, compliance assurance module 254b verifies adherence to rules. The module ensures that all API calls, particularly write requests that involve network parameter settings, comply with the dynamic, time-dependent, and location-dependent allowable ranges, whitelists, and/or blacklists defined by the RAN administrator. In cases of non-compliance, the compliance assurance module 254b may flag the API call for further evaluation by the conflict resolution module 256b or auditor module 258b to prevent adverse impacts on network performance. This may involve a combination of static rules (e.g., static ranges, whitelists, and blacklists) and/or dynamic rules (e.g., time-dependent constraints).

In one embodiment, conflict resolution module 256b addresses parameter conflicts. Together with the auditor module 258b, these two modules function as additional layers of prevention and/or oversight for write requests. The conflict resolution module 256b can prevent conflicts in the parameter settings initiated by different applications. For example, if an application's write request conflicts with an earlier setting made by another application, the conflict resolution module 256b will provide a mechanism to resolve this. In one or more embodiments, this can involve a prioritization system that determines which application's settings take precedence, or a negotiation mechanism that finds a compromise or other conflict resolution between the conflicting settings.

In one embodiment, the auditor module 258b evaluates the rationale of configuration requests. The auditor module 258b can be responsible for validation, cycle monitoring, and/or damage prevention of the write requests initiated by RAN automation applications. Together with the conflict resolution module 256b, these two modules function as additional layers of prevention for write requests. An additional layer of efficiency is provided by the auditor module 258b in a scenario where even if the parameter settings in write requests initiated by a RAN automation application pass the compliance assurance module 254b and conflict resolution module 256b, the parameter settings in write requests can still potentially impact the network adversely due to the complex interplay among different RAN parameters that the application is setting, as well as the current and/or future network status. Therefore, the role of the auditor module 258b is to ensure that write requests do not harm the network both instantaneously, and in the long run. To this end, the auditor module 258b does both a real-time auditing to conduct instantaneous assessment of the potential impact of a write request when the request arrives without introducing much delay, and a long-term post-setting auditing to track the long-term performance impact of the request and acts according to the estimated outcome of the write requests provided by the network simulator 276f.

In one embodiment, the auditor module 258b acts as a two-time-scale machine learning-based module, which includes a real-time analyzer 272f, a long-term analyzer 274f, and a network simulator 276f. Note that in view of the response time requirement in the near-RT RIC, as well as the relatively limited computation resources, the long-term analyzer 274f and network simulator 276f are an optional embodiment in the near-RT RIC oversight framework 216a. Further details regarding the functionality and workflows of these components are discussed later to provide a comprehensive understanding of their roles.

In some embodiments, network equipment is configured to enable resource reallocation across multiple RAN Intelligent Controllers, including both the non-RT RIC 208a and the near-RT RIC 216a. This resource reallocation can be facilitated by the near RT RIC oversight framework 210a and/or the non-RT RIC oversight framework 204a, which can identify areas where computational resources can be optimized to support the execution of auditing processes. By dynamically adjusting resource allocation, the network equipment allows both real-time and long-term auditing tasks to be performed efficiently, enhancing the overall performance and reliability of the network. This capability allows the network to adapt to varying demands and optimize or improve resource utilization, ensuring that auditing processes are supported without compromising network stability or performance.

In one embodiment, the feedback module 260b plays a role in providing feedback to RAN automation applications. This feedback can be based on each application's API calls and their corresponding impact on the network. Other factors can also be considered in deriving the feedback, including historical data, data for similar API calls in other systems, historical network performance trends, application-specific behavior patterns, and/or real-time network conditions that may influence decision-making processes. By integrating the feedback into the response messages of the API calls, the feedback module 260b ensures that the applications receive the correct and timely response of their API calls. Particularly, if an application learns that its former network configuration sent through the API call has been detected to have a negative impact on the network via the feedback module 260b, the application can use this information to improve itself, for example, through a machine learning mechanism. That way, the application will avoid making similar harmful network configuration requests in the future, creating a virtuous cycle.

In one embodiment, historical data repository module 262b stores the logs (or other data) of the non-RT RIC oversight framework 204a, which can include the details of API calls and their corresponding outcomes. Such data can be fed into an adaptive learning module 264b to dynamically update the strategies of API call monitoring modules, such as behavior monitoring module 252b, conflict resolution module 256b, and the auditor module 258b. Note that computation-intensive adaptive learning module 264b is usually done in the cloud-based non-RT RIC. Therefore, in a joint deployment of both the non-RT RIC oversight framework 204a and the near-RT RIC oversight framework 210a on both the non-RT RIC and near-RT RIC, the historical data repository module 262c at the near-RT RIC oversight framework 210a will periodically update its data to a centralized historical data repository at the non-RT RIC oversight framework 204a, so that the adaptive learning module 264b in the non-RT RIC oversight framework 204a can be called to help update the strategies for the corresponding modules in the near-RT RIC oversight framework 210a.

In one embodiment, the adaptive learning module 264b uses data-driven approaches and, using data provided by the historical data repository 262b, the adaptive learning module 264b dynamically updates the strategies in the behavior monitoring module 252b, conflict resolution module 256b, and auditor module 258b. Note that as a computation-intensive module, which in one embodiment is deployed in the non-RT RIC oversight framework 204a only, the adaptive learning module 264b takes the responsibility of updating the abovementioned modules not only in its own non-RT RIC oversight framework 204a, but also in the Near-RT RIC oversight framework 210a that it is connected to through the A1 interface 234a.

In one embodiment, the alarming module 266b module gathers alarms from various modules in the non-RT RIC oversight framework 204a. Upon collection, the alarming module notifies the RAN administrator 280b which can be an individual, an entity, and/or device(s), providing a timely snapshot of the system's latest happenings. In one embodiment utilizing a joint deployment scenario including both the near-RT RIC oversight framework 210a and non-RT RIC oversight framework 204a, the alarming module 266c in the near-RT RIC oversight framework 210a is optional. In this alternative embodiment the near-RT RIC oversight framework 210a can also make use of the alarming module 266b from the non-RT RIC oversight framework 204a for alarm issuing. In independent deployments, the near-RT RIC oversight framework 210a can use its own alarming module 266c to ensure alarm functionality.

In one embodiment, the Graphical User Interface (GUI) module 268b provides a GUI as an interface for the RAN administrator 280b to monitor the system. It provides real-time data visualization of the system health, as well as the status and operational statistics of different modules in the oversight framework. It also allows the RAN administrator to set compliance rules, such as whitelists and blacklists, through the GUI. In one embodiment utilizing the joint deployment scenario including both the near-RT RIC oversight framework 210a and non-RT RIC oversight framework 204a, the GUI module 268c in the near-RT RIC oversight framework 210a can be optional. The RAN administrator 280c can make use of the GUI module 286b from the non-RT RIC oversight framework 204a as a one-stop interface to set the configuration rules and/or other settings. In independent deployments, the near-RT RIC oversight framework 210a can use its own alarming module 266c to ensure alarm functionality.

In one embodiment, in the near-RT RIC oversight framework 210a deployment, xAPPs 212a communicate with the near-RT RIC 216a through the near-RT RIC API Interface at the near RT-RIC termination 236a. The near-RT RIC oversight framework 210a performs similar functions to its non-RT RIC oversight framework 204a counterpart, with behavior monitoring module 252c, compliance assurance module 254c, conflict resolution module 256c, and the auditor module 258c ensuring that API calls comply with standards and optimize or improve network configurations. However, the near-RT RIC oversight framework 210a and its modules can be specifically tailored to address the unique near-real-time operational requirements of xAPPs, which demand rapid decision-making and immediate adjustments to network configurations, making its presence important for maintaining stability and responsiveness in dynamic network environments.

In another embodiment, the feedback module 260c can provide feedback to xAPPs 212a, and the historical data repository 262c module can store relevant data related to the feedback. The alarming module 266c can alert the RAN administrator 280c to issues, such as anomalies caused by RAN automation applications, and the GUI module 268c can facilitates administrator interaction. The RAN administrator module 280c can oversee these operations, ensuring effective management of the network.

The A1 interface 234a connects the non-RT RIC and near-RT RIC, facilitating policy management and coordination between the two controllers. This interface enables the non-RT RIC to communicate long-term strategies to the near-RT RIC, ensuring that real-time operations align with strategic objectives. Through these components and connections, FIG. 2B illustrates the comprehensive oversight and management capabilities of the framework within the O-RAN architecture.

FIG. 2C1 and FIG. 2C2 are a block diagrams illustrating example, non-limiting embodiments of the non-RT RIC oversight framework 204a processing incoming read request from rAPPs 290c and incoming write requests from rAPPs 292c, with various aspects described herein. FIG. 2C1 and FIG. 2C2 provide a detailed view of the workflow and interactions involved in handling both read and write requests within the O-RAN architecture.

For instance, in one example scenario, an incoming read request from an rAPP 290c can be first subjected to the behavior monitoring module 252b to track the nature and frequency of the request. Once the request passes this initial stage, it can be passed to the compliance assurance module 254b to ensure adherence to predefined operational standards. If the request is determined as compliant, it can proceed to request execution 244c, where any necessary optimizations are applied, and the outcome is recorded in the historical data repository 262b for future analysis and strategy updates. Throughout this process, the alarming module 266b and GUI module 268b provide notifications and interface options for administrators to manage system health and operational statistics. The feedback module 260b can generate feedback to inform rAPPs of the impact of their API calls. This feedback can include performance metrics, such as how the API call affected key network indicators like latency, throughput, or signal quality. It can also provide compliance status notifications, indicating whether the API call adhered to predefined rules, whitelists, or blacklists. Additionally, the feedback can include resource utilization data, detailing the consumption of network resources such as CPU, memory, or bandwidth triggered by the API call. Conflict alerts can be issued to warn rAPPs about potential or actual conflicts with other API calls or network parameter settings. The module may also offer optimization suggestions, recommending modifications to future API calls to improve network performance or avoid adverse impacts. Historical comparisons can be provided, offering insights into how the current API call's impact compares to similar past calls, highlighting trends or deviations. The feedback may also include anomaly detection alerts, identifying unusual or unexpected behavior resulting from the API call, such as spikes in error rates or resource contention. This comprehensive feedback enables rAPPs to refine their operations and align their behavior with network performance goals and operational standards.

In another example, as illustrated in FIG. 2C2, an incoming write request from rAPPs 292c can follow a parallel process. The request can be initially monitored by the behavior monitoring module 252b and, if it passes, it can be subjected to the compliance assurance module 254b. In an example, upon passing the compliance assurance module 245b, the request enters the conflict resolution module 256b to address any potential parameter conflicts. If resolved, the request is evaluated by the auditor module 258b to assess the write request impact on network performance. The write request is then sent to request execution 244c, with any necessary tuning applied. This tuning could include but is not limited to, modifying network configuration parameters to prevent potential harm to network performance and/or stability. For instance, the tuning process may involve calibrating transmission power levels to avoid interference, reallocating bandwidth to prevent offloading a particular cell, or adjusting scheduling priorities to mitigate delays that could degrade the service quality of time-sensitive applications. Other examples of tuning might involve refining resource allocation to prevent/reduce contention, dynamically adjusting thresholds for triggering alarms to avoid false alarms or unnecessary escalations, or fine-tuning configuration settings to ensure they remain within safe and sustainable network operational limits in response to real-time network conditions and performance goals. After the write request is executed the results are recorded in the historical data repository 262b for future reference. The alarming module 266b and GUI 268b continue to provide notifications and interface options, while the feedback model 260b informs the rAPP of the outcome and/or any needed adjustments. For write requests, this feedback can include an analysis of how the changes impacted network parameters such as transmission power or bandwidth allocation, along with recommendations for resolving conflicts with existing settings or other applications' requests. It may also provide compliance notifications, indicating adherence to operational rules, and optimization suggestions for refining future write requests. Additionally, the feedback could include predictions of long-term impacts on network stability and resource utilization, enabling the rAPP to make proactive adjustments to improve network performance.

FIG. 2D is a block diagram illustrating an example, non-limiting embodiment of the near-RT RIC Oversight framework 204a processing a read request from xAPPs 294d, referred to as system 200d, in accordance with various aspects described herein. System 200d provides a detailed view of the workflow and interactions involved in handling read requests within the O-RAN architecture. In an optional joint deployment scenario, the non-RT RIC oversight framework 204a may also contribute to the process through shared use of its alarming module 266b, historical data repository module 262b, and adaptive learning module 264b, which provide centralized alarming, data updates, and strategy refinements via the A1 interface, ensuring alignment and coordination between the non-RT RIC and near-RT RIC oversight frameworks.

In one example, an incoming read request from xAPPs 294d can be first subjected to the behavior monitoring module 252c to track the nature and frequency of the request. Once the request passes this initial stage, the read request can be sent to the compliance assurance module 254c to ensure adherence to predefined operational standards. If the request is compliant, it proceeds to request execution 244c, where any necessary optimizations are applied, and the outcome is recorded in the historical data repository 262b for future analysis and strategy updates.

The alarming module 266b and GUI module 268b provide notifications and interface options for administrators to manage system health and operational statistics. The feedback module 260b can generate feedback to inform xAPPs of the impact of their API calls. In the near-RT RIC oversight framework 210a, the feedback module 260c generates feedback specific to xAPPs, such as providing real-time insights into how their API calls affect network performance metrics like latency, throughput, and resource utilization. This feedback helps xAPPs refine their operations and align with real-time network goals. The historical data repository 262b can store the results for future reference and strategy updates. In FIG. 2D, the alarming module 266b and GUI module 268b are shown for the non-RT RIC oversight framework 204a, their use in the context of the near-RT RIC oversight framework 210a can be optional and dependent on the deployment scenario. The historical data repository 262b can be utilized to provide centralized data updates and support strategy refinements via the A1 interface. The near-RT RIC oversight framework 210a can also use its own historical data repository 262c to store localized results and support independent analysis, for example in deployments where centralized updates from 262b are not available.

In an optional joint deployment scenario, the near-RT RIC oversight framework 210a can rely on the historical data repository 262b from the non-RT RIC oversight framework 204a for periodic updates and adaptive learning. The alarming module 266c and GUI module 268c in the near-RT RIC oversight framework 210a can be used for alarming and administrative interactions, particularly in independent deployments. Alternatively, in a joint deployment scenario, the near-RT RIC oversight framework 210a may rely on the centralized alarming module 266b and GUI module 268b from the non-RT RIC oversight framework 204a, ensuring streamlined operations and reducing redundancy.

FIG. 2E is a block diagram illustrating an example, non-limiting embodiment of the near-RT RIC Oversight framework 210a processing an incoming write request from an xAPPs 296e, referred to as system 200e, in accordance with various aspects described herein. System 200e provides a detailed view of the workflow and interactions involved in handling write requests within the O-RAN architecture.

For example, an incoming write request from xAPPs 296e is first subjected to the behavior monitoring module 252c to track the nature and frequency of the request. Once the request passes this initial stage, it can be passed to the compliance assurance module 254c to ensure adherence to predefined operational standards. If the write request request is compliant, it is passed to the conflict resolution module 256c to address any potential parameter conflicts. If resolved, the request is evaluated by the auditor module 258c to assess the impact on network performance. The request is then executed by request execution 244c, with any necessary tuning applied, and the outcome is recorded in the historical data repository module 262c for future analysis and strategy updates. The alarming module 266c and GUI module 268c can provide notifications and interface options for administrators to manage system health and operational statistics. The feedback module 260c can generate feedback to inform xAPPs of the impact of their API calls, such as the impact of the changes on network parameters, compliance with operational standards, and recommendations for future adjustments. The historical data repository 262c can store the results for future reference and strategy updates while also supporting adaptive learning processes to refine monitoring and auditing strategies over time.

In a joint non-RT RIC and near-RT RIC deployment using both the non-RT RIC oversight framework 204a and the near-RT RIC oversight framework 210a, updates are facilitated through the A1 interface, ensuring that both controllers are aligned with strategic objectives. The non-RT RIC Oversight framework 204a also includes an alarming module 266b, GUI module 268b, and historical data repository module 262b which can support comprehensive oversight and management. These modules can be optionally used instead of the near-RT RIC oversight framework's alarming module 266c, GUI module 268c, and historical data repository module 262c to centralize operations, reduce redundancy, and leverage the greater computational resources typically available in the non-RT RIC. This centralization can be particularly beneficial in scenarios where the near-RT RIC has limited computational resources or where streamlined operations across both controllers are desired.

FIG. 2F is a block diagram illustrating an example, non-limiting embodiment of the non-RT RIC Oversight framework's auditor module 258b processing write requests from rAPPs 292c, in accordance with various aspects described herein. FIG. 2F provides a detailed view of the auditing process, focusing on real-time and long-term analysis within the O-RAN architecture.

An incoming write request from rAPPs 292c can be first evaluated by the Real-Time Analyzer 272f, which conducts an instantaneous assessment to determine the immediate impact of the request on network performance and ensure swift response. In one embodiment, the real-time analyzer 272f can make a decision or determination to pass, tweak and pass, or block the request based on its analysis. For the decision to pass, if the write request is deemed compliant with operational standards and poses no immediate risk to network stability, the real-time analyzer 272f allows the request to proceed without modification. This decision indicates that the request aligns with policies such as predefined policies, and it is predicted to be unlikely that the request will negatively impact network performance. For the decision to tweak and pass, the write request partially complies with standards but requires (or it is determined that) adjustments be made to mitigate potential risks, the real-time analyzer 272f modifies the request before allowing it to proceed. This decision involves altering specific parameters or configurations to ensure that the request does not adversely affect the network. The adjustments can be made to optimize or improve the request's impact on the network while maintaining compliance with operational standards. For the decision to block, the write request is found to be non-compliant or poses a risk (e.g., a significant risk such as determined according to a threshold) to network stability, and the real-time analyzer 272f blocks the request entirely. This decision can be made to prevent any potential negative impacts on the network, ensuring that only safe and compliant requests are processed. If the request passes, the Real-Time Analyzer assigns a risk level to the subsequent long-term analyzer 274f.

The long-term analyzer 274f can track the write request from rAPPs 292c over a specified period, depending on the assigned risk level. This risk level dictates the duration and depth of monitoring, with higher-risk requests undergoing more rigorous evaluation. The long-term analyzer 274f continuously, frequently or according to another timing scheme monitors the network's performance feedback and utilizes the network simulator 276f to estimate potential long-term impacts, providing a predictive analysis of future network behavior under the new configurations. This simulation capability allows the long-term analyzer 274f to anticipate issues before they arise, enabling proactive network management. If any negative effects are observed or predicted, the long-term analyzer 274f issues a decision to tweak or otherwise adjust the network configuration previously set by the write request or revoke the request entirely.

FIG. 2G is a block diagram illustrating an example, non-limiting embodiment of the near-RT RIC Oversight framework's auditor module 258b processing write requests from xAPPs 294d, in accordance with various aspects described herein. FIG. 2G provides a detailed view of the auditing process, focusing on real-time and optional long-term analysis within the O-RAN architecture.

An incoming write request from xAPPs 294d can first be evaluated by the real-time analyzer 272g, which conducts an instantaneous assessment to determine the immediate impact of the request on network performance and ensure swift response. The real-time analyzer 272g can make a decision to pass, tweak and pass, or block the request based on its analysis. If the request passes, the real-time analyzer 272g assigns a risk level to the subsequent long-term analyzer 274f, which in one or more embodiments can be optional in the near-RT RIC environment in view of resource constraints. The real-time analyzer 272g can be distinct from the earlier real-time analyzer 272f described in FIG. 2F, as it is specifically designed to meet the strict timing requirements of the near-RT RIC oversight framework 210a, where rapid decision-making is critical for real-time network adjustments and optimization.

The long-term analyzer 274f, when optionally utilized in a joint deployment of the of the near-RT RIC oversight 210a and non-RT RIC oversight 204a, or optionally utilized in an individual deployment of the near-RT RIC oversight 210a, can track a write request over a specified period or timeframe, depending on the assigned risk level. It continuously, frequently or according to another timing scheme monitors the network's performance feedback and optionally utilizes the network simulator 276f to estimate potential long-term impacts. If any negative effects are observed or predicted, the long-term analyzer 274f can issue a decision to tweak or otherwise adjust the network configuration previously set by the write request or revoke the request entirely.

FIG. 2H is a block diagram illustrating an example, non-limiting embodiment of the non-RT RIC oversight framework 204a conducting automated periodic updates to monitoring strategies using the adaptive learning module 264b, referred to as system 200h, in accordance with various aspects described herein. System 200h provides a detailed view of how the adaptive learning module 264b is utilized to enhance the oversight framework within the O-RAN architecture.

The historical data repository module 262b stores logs or other data (which can include metadata) of API calls and their outcomes, providing a comprehensive dataset for analysis. The adaptive learning module 264b leverages this historical data to dynamically update the strategies employed by various modules within the non-RT RIC oversight framework 204a. These modules include the behavior monitoring module 252b, the conflict resolution module 256b, and the auditor module 258b, which are periodically updated to improve their effectiveness in managing network operations. The adaptive learning module 264b could employ various machine learning, data-driven, artificial intelligence, and/or computational intelligence techniques, such as supervised learning to refine compliance rules based on labeled data, unsupervised learning to detect anomalies in API call patterns, reinforcement learning to optimize decision-making strategies over time, and/or deep learning to analyze complex interactions between network parameters. It could also use generative AI to simulate potential network scenarios, Bayesian networks to model probabilistic relationships between API calls and network outcomes, or fuzzy logic to handle uncertainty in parameter settings. Additionally, clustering algorithms could be applied to group similar API call behaviors, while support vector machines (SVMs) could classify API calls as compliant or non-compliant. Ensemble methods, such as random forests or gradient boosting, could further enhance prediction accuracy, and neural networks could be used to identify nonlinear relationships in network data.

In some embodiments, the periodic updates facilitated by the adaptive learning module 264b extend to the near-RT RIC Oversight framework 210a, where the behavior monitoring module 252c, conflict resolution module 256c, and the auditor module 258c are similarly enhanced. The updates are communicated through the A1 interface, ensuring that both the non-RT RIC and near-RT RIC are aligned with the latest strategies and insights. FIG. 2H illustrates an instance of such an update, referred to as update periodic update through Ai interface n, showing how the adaptive learning module 264b refines strategies and propagates them across oversight frameworks.

FIG. 2I is a block diagram illustrating an example, non-limiting embodiment of the non-RT RIC oversight framework 204a receiving rule-based updates from a RAN administrator in a joint non-RT RIC and near-RT RIC deployment, referred to as system 200i, in accordance with various aspects described herein. System 200i provides a detailed view of how rule-based updates are integrated into the oversight framework to enhance network management within the O-RAN architecture.

In one example, the RAN administrator 280b plays a central role in managing the oversight framework by inputting rules through the Graphical User Interface (GUI) 268b. This interface allows the administrator to visualize system health, operational statistics, and update compliance rules, whitelists, and blacklists. The rules 280i, which may include dynamic, time-dependent, and location-specific constraints, are propagated across the oversight framework to ensure consistent enforcement and alignment with operational standards. The adaptive learning module 264b processes these rule-based updates, ensuring that both the non-RT RIC oversight framework 204a and near-RT RIC oversight framework 210a remain aligned with the latest operational standards and strategies.

Within the non-RT RIC oversight framework 204a, several modules can be updated based on the RAN administrator 280b input. These include the behavior monitoring module 252b, compliance assurance module 254b, conflict resolution module 256b, and the auditor module 258b. These modules can be responsible for evaluating API calls, ensuring compliance, resolving conflicts, and auditing network configurations, respectively.

In the near-RT RIC oversight framework 210a, the same modules can be updated via the A1 interface to reflect the rules input from the RAN administrator 280b. The modules can include the behavior monitoring module 252c, compliance assurance module 254c, conflict resolution module 256c, and the auditor module 258c, which are enhanced by the rules to maintain network stability and performance. In an example joint non-RT RIC oversight framework 204a and near-RT RIC oversight framework 210a deployment, the updates are communicated through the A1 interface, ensuring that both the non-RT RIC and near-RT RIC are synchronized with the latest strategies.

FIG. 2I additionally depicts an iterative update process, where an update through A1 interface n represents another version or iteration of updates sent to the behavior monitoring module 252c, compliance assurance module 254c, conflict resolution module 256c, and the auditor module 258c. Through these rule-based updates, FIG. 2I illustrates how the oversight framework adapts to new policies and strategies, optimizing or improving its capabilities to maintain a reliable and efficient O-RAN-based network.

While for purposes of simplicity of explanation, the respective processes are shown and described as a series of blocks in FIG. 2A-I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

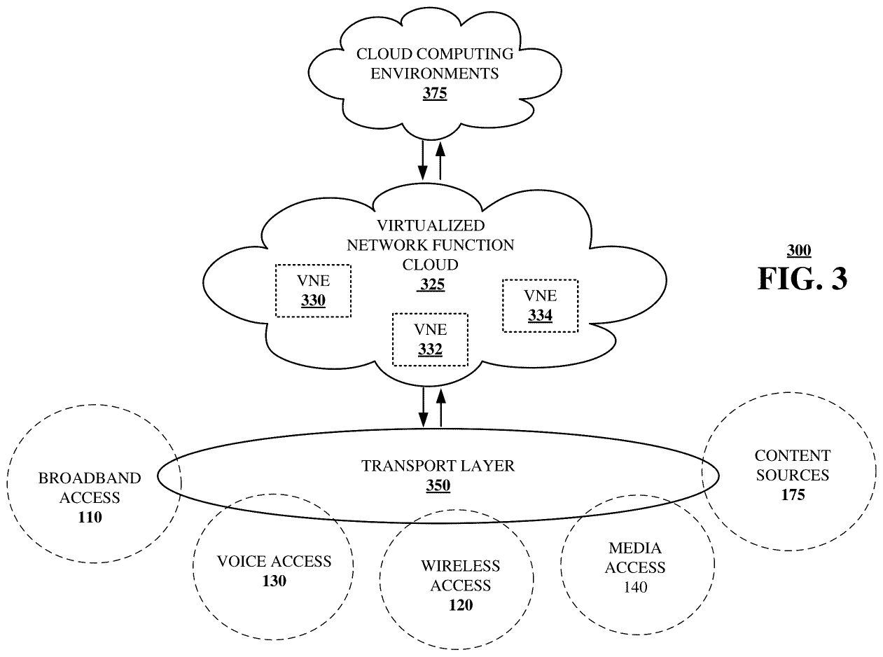

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A-I, and 3. For example, virtualized communication network 300 can facilitate in whole or in part the implementation of the oversight framework by leveraging its cloud-based infrastructure to manage and optimize API calls made by RAN automation applications. The network can evaluate these API calls, which include read requests for network data and write requests for network configuration parameters, ensuring they comply with operational standards. Additionally, the network can generate feedback to RAN automation applications through response messages to API calls, reflecting the impact of these calls on network performance.

In one embodiment, the Virtual Network Elements (VNEs) within the virtualized communication network 300 can dynamically reallocate network resources based on requests from the oversight framework. This capability allows the network to respond to real-time demands and optimize resource utilization, ensuring efficient operation and enhanced performance. The oversight framework can identify areas where resource adjustments are needed, and the VNEs can execute these changes, maintaining network stability and supporting the execution of complex auditing and feedback processes.

The virtualized communication network 300 can also issue alarms based on detected anomalies or non-compliance in API calls, providing timely notifications to network administrators. Furthermore, the network can resolve conflicts in network parameter settings initiated by the RAN automation applications, optimizing configurations to maintain network stability and performance. By integrating these capabilities, the virtualized communication network 300 supports the comprehensive oversight and management functions of the framework, enhancing the reliability and efficiency of O-RAN-based networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

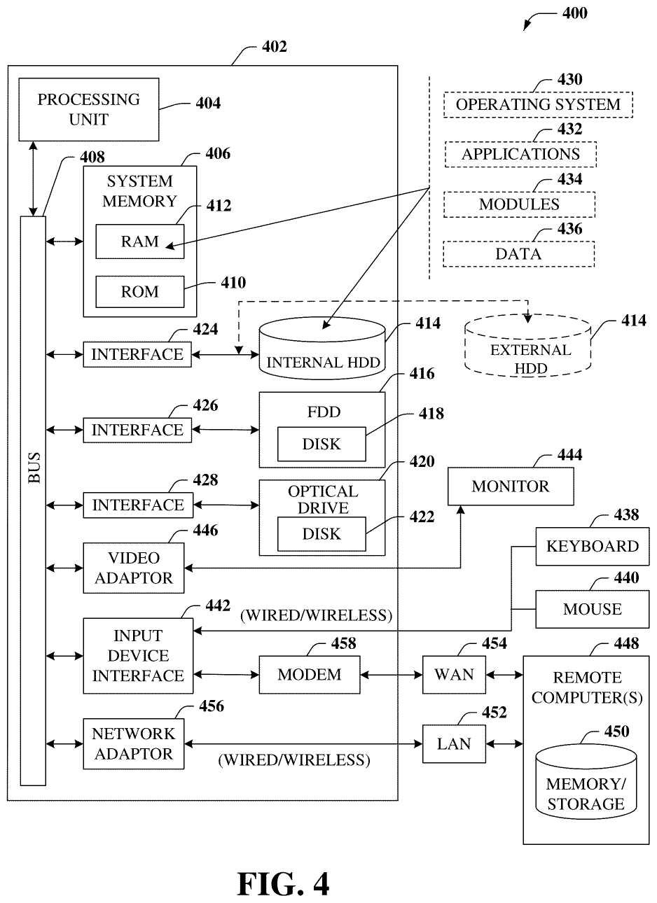

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part the implementation of the oversight framework by providing the necessary processing and storage capabilities to manage and optimize API calls made by RAN automation applications. The processing unit (404) within the computing environment can execute instructions stored in the system memory (406), enabling the evaluation of API calls, which include read requests for network data and write requests for network configuration parameters, ensuring compliance with operational standards.

The computing environment 400 can also generate feedback to RAN automation applications through response messages to API calls, reflecting the impact of these calls on network performance. The system can issue alarms based on detected anomalies or non-compliance in API calls, providing timely notifications to network administrators. Additionally, the computing environment can resolve conflicts in network parameter settings initiated by the RAN automation applications, optimizing configurations to maintain network stability and performance.

By integrating these capabilities, the computing environment 400 supports the comprehensive oversight and management functions of the framework, enhancing the reliability and efficiency of O-RAN-based networks. The environment's ability to process and store large volumes of data ensures that the oversight framework can effectively monitor and manage network operations, contributing to the overall stability and performance of the communication network.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

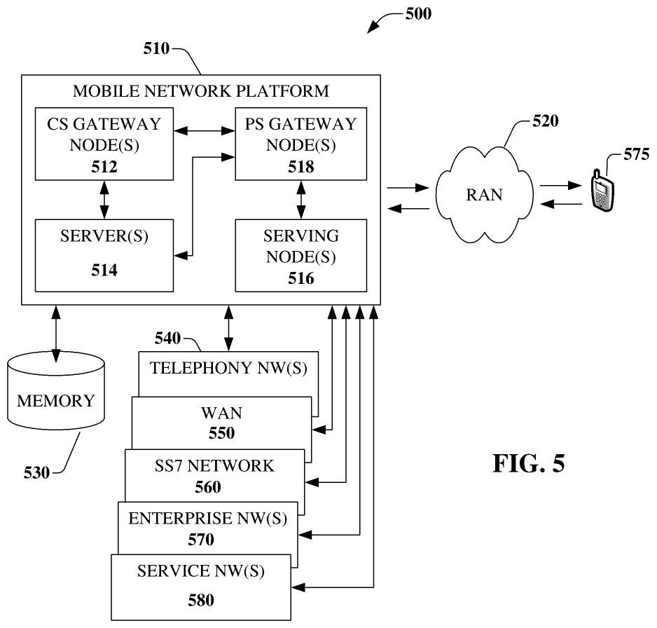

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part the evaluation of API calls made by RAN automation applications, generating feedback to these applications based on their impact on network performance, issuing alarms for detected anomalies or non-compliance, and resolving conflicts in network parameter settings to ensure efficient and reliable network operations. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

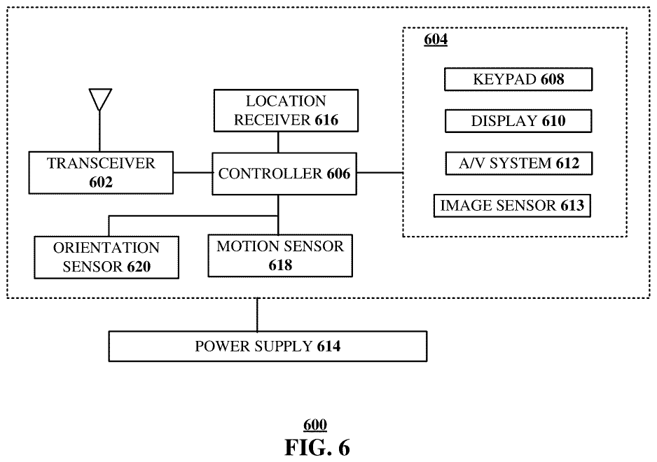

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part the evaluation of API calls made by RAN automation applications, generating feedback to these applications based on their impact on network performance, issuing alarms for detected anomalies or non-compliance, and adjusting network parameter settings to ensure optimal network performance.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be a part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be a part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, handheld computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïe Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” “subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
evaluating, by a processing system including a processor, API calls made by RAN automation applications, wherein the API calls include read requests for network data and write requests for network configuration parameters; and
based on the evaluating, providing, by the processing system, to at least a portion of the RAN automation applications, response messages associated with at least a portion of the API calls, wherein the response messages include feedback that reflects an impact of the API calls on a network performance.

2. The method of claim 1, comprising:
auditing, by the processing system, the API calls to assess potential impact on the network performance, wherein the auditing is facilitated by data-driven approaches to predict adverse effects on the network performance, wherein the auditing is performed over a longer time period than the evaluating.

3. The method of claim 2, comprising:
accessing, by the processing system, historical data associated with other API calls and other network performance associated with the other API calls from a historical data repository, wherein the other API calls are associated with network functions corresponding to the API calls, and wherein the auditing is based upon applying the data-driven approaches to the historical data.

4. The method of claim 2, comprising:
detecting, by the processing system, a performance metric associated with the network performance failing to satisfy a performance threshold; and
providing, by the processing system, resource reallocation across one or more RAN Intelligent Controllers responsive to the detecting and based on at least one of the evaluating, the auditing, or a combination thereof.

5. The method of claim 1, further comprising:
detecting, by the processing system, an anomaly or a non-compliance in a particular API call of the API calls according to the feedback resulting in a detected anomaly or non-compliance; and
generating, by the processing system, an alarm based on the detected anomaly or non-compliance in the particular API call.

6. The method of claim 1, further comprising:
identifying, by the processing system, a conflict in one or more network parameter settings initiated by the RAN automation applications, wherein the identifying of the conflict is based on at least one of the evaluating of the API calls, the feedback, or a combination thereof.

7. The method of claim 1, wherein the evaluating of the API calls is based on at least one of compliance rules, whitelists, blacklists or a combination thereof, and further comprising:
providing, by the processing system, a graphical user interface (GUI) that enables adjusting of the at least one of compliance rules, whitelists, blacklists or a combination thereof.

8. The method of claim 2, comprising:
generating, by the processing system, policy information according to the evaluating and the auditing, wherein the policy information is associated with adjusting the API calls from rAPPs and xAPPs; and
communicating, by the processing system, the policy information from a non-real-time RAN Intelligent Controller (non-RT RIC) to a near-real-time RAN Intelligent Controller (near-RT RIC).

9. The method of claim 1, comprising:
responsive to at least one of the evaluating, auditing, or a combination thereof, implementing, by the processing system, a rate-limiting mechanism to control a frequency of a particular type of API call of the API calls made by one or more of the RAN automation applications.

10. A processing system, comprising:
a processor; and
a memory that stores executable instructions that, when executed the processing system, facilitate performance of operations, the operations comprising:
evaluating API calls made by RAN automation applications, wherein the API calls include at least one of read requests for network data, write requests for network configuration parameters, or a combination thereof, wherein the evaluating includes determining an impact of the API calls on a network performance; and
auditing the API calls to assess potential impact on the network performance, wherein the auditing is facilitated by data-driven approaches to predict adverse effects on the network performance, wherein the auditing is performed over a longer time period than the evaluating.

11. The processing system of claim 10, wherein the operations further comprise:
based on the evaluating, providing, to at least a portion of the RAN automation applications, response messages associated with at least a portion of the API calls, wherein the response messages include feedback that reflects an impact of the API calls on a network performance.

12. The processing system of claim 10, wherein the operations further comprise:
accessing, from a historical data repository, historical data associated with other API calls and other network performance associated with the other API calls, wherein the other API calls are associated with network functions corresponding to the API calls, and wherein the auditing is based upon applying the data-driven approaches to the historical data.

13. The processing system of claim 11, wherein the operations further comprise:
identifying a conflict in one or more network parameter settings initiated by the RAN automation applications, wherein the identifying of the conflict is based on at least one of the evaluating of the API calls, the feedback, or a combination thereof.

14. The processing system of claim 10, wherein the evaluating of the API calls is based on at least one of compliance rules, whitelists, blacklists or a combination thereof, and further comprising:
providing a graphical user interface (GUI) that enables adjusting of the at least one of compliance rules, whitelists, blacklists or a combination thereof.

15. A non-transitory machine-readable medium, comprising executable instructions that, when executed by a processing system including a processor of a device, facilitate performance of operations, the operations comprising:
evaluating API calls made by RAN automation applications, wherein the API calls include read requests for network data and write requests for network configuration parameters; and
based on the evaluating, providing, to at least a portion of the RAN automation applications, response messages associated with at least a portion of the API calls, wherein the response messages include feedback that reflects an impact of the API calls on a network performance.

16. The non-transitory machine-readable medium of claim 15, comprising:
auditing the API calls to assess potential impact on the network performance, wherein the auditing is facilitated by data-driven approaches to predict adverse effects on the network performance, wherein the auditing is performed over a longer time period than the evaluating.

17. The non-transitory machine-readable medium of claim 16, comprising:
accessing historical data associated with other API calls and other network performance associated with the other API calls from a historical data repository, wherein the other API calls are associated with network functions corresponding to the API calls, and wherein the auditing is based upon applying the data-driven approaches to the historical data.

18. The non-transitory machine-readable medium of claim 16, comprising:
detecting a performance metric associated with the network performance failing to satisfy a performance threshold; and
providing resource reallocation across one or more RAN Intelligent Controllers responsive to the detecting and based on at least one of the evaluating, the auditing, or a combination thereof.

19. The non-transitory machine-readable medium of claim 15, comprising:
detecting an anomaly or a non-compliance in a particular API call of the API calls according to the feedback resulting in a detected anomaly or non-compliance; and
generating, by the processing system, an alarm based on the detected anomaly or non-compliance in the particular API call.

20. The non-transitory machine-readable medium of claim 15, comprising:
identifying a conflict in one or more network parameter settings initiated by the RAN automation applications, wherein the identifying of the conflict is based on at least one of the evaluating of the API calls, the feedback, or a combination thereof.
